(19) United States
(12) Patent Application Publication
(10) Pub. No.: US 2022/0212821 A1
(43) Pub. Date: Jul. 7, 2022

(54) Protein Preparation And Packaging Methods, Systems And Related Devices

(71) Applicant: Iowa Pacific Processors, Inc., Des Moines, IA (US)

(72) Inventor: Michael Everett, Kaneohe, HI (US)

(21) Appl. No.: 17/613,237

(22) PCT Filed: Nov. 22, 2019
(86) PCT No.: PCT/US19/62753

§ 371 Date: Nov. 22, 2021

Related U.S. Application Data
(63) Continuation-in-part of application No. 16/419,359, filed on May 22, 2019.
(60) Provisional application No. 62/899,068, filed on Sep. 11, 2019.

(51) Int. Cl. B65B 25/06; A23B 4/16; A23B 4/24; A23L 3/3418; A23L 3/358; A23L 3/3589; A23L 3/015; B65B 5/04; B65B 55/18

(52) U.S. Cl. CPC B65B 25/067; A23B 4/16; A23B 4/24; A23L 3/3418; A23V 2002/00; A23L 3/3589; A23L 3/015; B65B 5/045; B65B 55/18; A23L 3/358

(57) ABSTRACT

The disclosed apparatus, systems and methods relate to preparation, modified atmosphere and high pressure pasteurization steps for treatment of retail fresh protein preparations. Protein is prepared and subsequently packaged in a modified atmosphere lacking significant amounts of oxygen and then exposed to high-pressure pasteurization. During preparation the protein may be exposed to aqueous ozone further reducing the microbial load, extending shelf-life, and increasing product safety.

### CROSS-REFERENCE TO RELATED APPLICATIONS

This application claims priority to U.S. Provisional Application 62/899,068 filed Sep. 11, 2019, and entitled “Protein Preparation and Packaging Methods, Systems and Related Devices”. This application claims priority to and is a continuation-in-part application of U.S. application Ser. No. 16/419,359 filed May 22, 2019, and entitled “Protein Preparation and Packaging Methods, Systems, and Related Devices”, which is a continuation-in-part application of U.S. application Ser. No. 15/932,235 filed Feb. 16, 2018, and entitled “Modified Atmosphere and High-Pressure Pasteurization Protein Preparation Packaging Methods, Systems and Related Devices,” which claims priority to U.S. Provisional Application 62/459,888 filed Feb. 16, 2017, and entitled “Protein Preparation Systems, Devices and Related Methods.” All of the above applications are hereby incorporated by reference in their entirety under 35 U.S.C. § 119(e).

### TECHNICAL FIELD

The disclosure relates to devices, systems, and methods for the preparation and storage of proteins. Namely, the disclosure relates to a packaging system, devices and methods that allow for a significant reduction in pathogens, extended shelf-life, and increased food safety of various proteins, such as fresh beef, lamb, pork, poultry, fish, fowl and bison.

### BACKGROUND

Prior art retail protein presentation methods and devices often present a number of shortcomings. These shortcomings can include pathogens and limited shelf life for fresh meat, such as beef, lamb, pork, poultry, fish, fowl, bison and the like, as well as other meat alternative forms of protein known in the art (hereinafter generally referred to as “protein”). Also, less skilled labor in the protein sector, increasing overhead, lack of traceability, and regimented advertisement campaigns create difficulties that are not in tune to market opportunities.

Under prior art approaches, protein suppliers generally fabricate carcasses into so-called “subprimals” which are typically cryovac or vacuum packaged. In this subprimal state the protein typically has a shelf life of approximately the following: beef/lamb 40 days, pork 15 days and chicken 7 days. These proteins are also often contaminated with various pathogens which can be harmful to the consumer if not cooked properly.

There is a need in the art for improved methods of protein preparation.

### BRIEF SUMMARY

Described herein are various embodiments relating to devices, systems and methods for protein processing, packaging and preparation. Although multiple embodiments, including various devices, systems, and methods are described herein as a “system,” this is in no way intended to be restrictive or limiting.

In one example, a system for retail protein preparation, including: a modified atmosphere device configured to seal the protein in a modified atmosphere; and a high-pressure pasteurization device configured to pasteurize the sealed protein. Implementations may include one or more of the following features. The system where the modified atmosphere includes carbon monoxide. The system where the modified atmosphere includes carbon dioxide. The system where the modified atmosphere includes nitrogen. The system where the modified atmosphere includes carbon dioxide, carbon monoxide, and nitrogen. The system where the modified atmosphere does not include oxygen. Other embodiments include corresponding computer systems, apparatus, and computer programs recorded on one or more computer storage devices, each configured to perform the actions of the methods. Implementations of the described techniques may include hardware, a method or process, or computer software on a computer-accessible medium.

Another example includes a method for fresh retail protein preparation, including operating a packaging system including a modified atmosphere device configured to expose the protein to a modified atmosphere and seal the protein in a container. The method of this example also includes a high-pressure pasteurization device constructed and arranged to pasteurize the sealed protein within the sealed container, where the system is configured to perform steps including a modified atmosphere step, and a high-pressure pasteurization step, where the protein is sealed in a modified atmosphere and exposed to high pressure pasteurization.

Implementations according to this and other examples may include one or more of the following features. The method where the modified atmosphere includes carbon monoxide. The method where the modified atmosphere includes carbon dioxide. The method where the modified atmosphere includes nitric oxide. The method where the modified atmosphere includes carbon dioxide, carbon monoxide and nitrogen. The method where the modified atmosphere does not include oxygen.

Another example includes a method for high-pressure pasteurization of protein, including at least one modified atmosphere step where the protein is sealed in a modified atmosphere, and at least high-pressure pasteurization step performed on the sealed modified atmosphere protein.

Yet a further example includes a method of packaging protein in a modified atmosphere for high-pressure pasteurization, including several steps a preparation step, including a physical preparation sub-step and a chemical preparation sub-step, a modified atmosphere step including a modified atmosphere introduction sub-step and a sealing sub-step, and a high-pressure pasteurization step including a high pressure pasteurization sub-step, where the protein is sealed and high-pressure pasteurized in a container with a modified atmosphere including carbon monoxide, carbon dioxide, and nitrogen without substantial oxygen.

Implementations of these examples may include one or more of the following features. The method where the modified atmosphere step includes a modified atmosphere sub-step, and a sealing sub-step. The method where the modified atmosphere includes carbon monoxide, carbon dioxide, and nitrogen. The method where the modified atmosphere includes carbon monoxide, carbon dioxide, and nitrogen. The method where the modified atmosphere includes about 0.4% carbon monoxide. The method where the modified atmosphere includes about 20% carbon dioxide. The method where the modified atmosphere includes more than 79% nitrogen. The method where the high-pressure pasteurization step includes a coding/dating sub-step and a scanning sub-step. The method where the high-pressure pasteurization step includes an high pressure pasteurization (“HPP”) sub-step. The method where the HPP sub-step is performed on the sealed modified atmosphere protein at about 87,000 psi. The method where the HPP sub-step is performed on the sealed modified atmosphere protein for about 3 minutes. The method where the HPP sub-step is performed on the sealed modified atmosphere protein for between about 1 second and about 3600 seconds. The method where the HPP sub-step is performed on the sealed modified atmosphere protein at between about 43,500 and about 87,000 psi.

Another example includes a method for packaging proteins including a preparation step including: providing a protein; exposing the protein to an aqueous ozone solution; placing the protein in a container. The method may also include a modified atmosphere step including introducing a modified atmosphere into the container and sealing the container. The method may also include a high-pressure pasteurization step including exposing the container to high pressure pasteurization. The method may also include storing the container.

Implementations may include one or more of the following features. The method where the aqueous ozone solution is about 0.5 to about 4 ppm aqueous ozone. The method where the protein is exposed to the aqueous ozone solution for 1 to 10 seconds. The method further including portioning the protein after exposing to the aqueous ozone solution. The method further including coding and dating the container. The method where the high-pressure pasteurization is at least about 72,000 psi. The method where the high-pressure pasteurization is at least about 3 minutes.

Another example, includes a method for extending the shelf life of a food product including: providing a food product, exposing the food product to an aqueous ozone solution, placing the food product into a package, flushing the package with a modified atmosphere, sealing the package, and exposing the package to high pressure pasteurization.

Implementations may include one or more of the following features. The method where the food product is exposed to the aqueous ozone solution for 1 to 10 seconds. The method where the aqueous ozone solution includes 0.5 to 4 ppm of aqueous ozone. The method where the modified atmosphere is substantially without oxygen. The method where the aqueous ozone solution is exposed to the food product via spray nozzles. The method where the high-pressure pasteurization is at least 72,000 psi for at least 3 minutes. The method where the shelf-life of the food product is extended by at least 60 days.

In another example, a system for processing proteins including: an aqueous ozone application unit; a packager in communication with the aqueous ozone application unit; a modified atmosphere injector in communication with the packager; a sealer in communication with the packager and modified atmosphere injector; and a high-pressure pasteurization tank in connection with the packager. In this example, a protein is exposed to aqueous ozone in the aqueous ozone application unit; the protein is placed into a package by the packager; the package is flushed with a modified atmosphere by the modified atmosphere injector; the package is sealed by the sealer while flushed with the modified atmosphere; and the protein is exposed to high-pressure pasteurization in the high-pressure pasteurization tank.

Implementations may include one or more of the following features. The system where the aqueous ozone solution is 0.5 to 4 ppm of aqueous ozone. The system where the protein is exposed to aqueous ozone for 1 to 10 seconds. The system where the self-life of the protein is extended by at least 30 days. The system where the self-life of the protein is extended by at least 45 days. The system where the self-life of the protein is extended by at least 60 days. The system where the protein is beef.

In various implementations featuring automation, a system of one or more components including computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

While multiple implementations are disclosed, still other implementations of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is an illustrative flow diagram of the protein packaging process, according to exemplary implementations.

FIG. 2A is a perspective view of a aqueous ozone application unit, according to one implementation.

FIG. 2B is a top-view floorplan of a facility capable of performing the protein packaging process, according to one implementation.

FIG. 3 is a perspective view of a several components utilized in the process, including a weighing device, according to one implementation.

FIG. 4 is a perspective view of a modified atmosphere device comprising a conduit and bagging chute, according to one implementation.

FIG. 5 is an end-long view of the modified atmosphere device of FIG. 4.

FIG. 6 is a perspective view of a bagged and sealed protein in a modified atmosphere on a conveyor belt, according to one implementation.

FIG. 7 is a perspective view of a conveyor and high pressure pasteurization device, according to one implementation.

FIG. 8 is a further perspective view of a high pressure pasteurization device, according to one implementation.

FIG. 9 is yet a further side view of a high pressure pasteurization device, according to one implementation.

### DETAILED DESCRIPTION

The various embodiments disclosed or contemplated herein are directed to systems, methods and devices for packaging of protein in an air-tight bag or other container, wherein the protein is exposed to a modified atmosphere within the bag and the bag is exposed to high-pressure pasteurization (“HPP”). In some implementations the protein is additionally exposed to aqueous ozone prior to packaging. In various implementations, the HPP has an extended decompression time. In various implementations, a variety of automated or semi-automated components can be used to execute a variety of steps and sub-steps to prepare such packaged protein. These implementations can improve shelf-life, aesthetic quality, and other features and properties of the prepared and packaged protein, as will be described in detail herein.

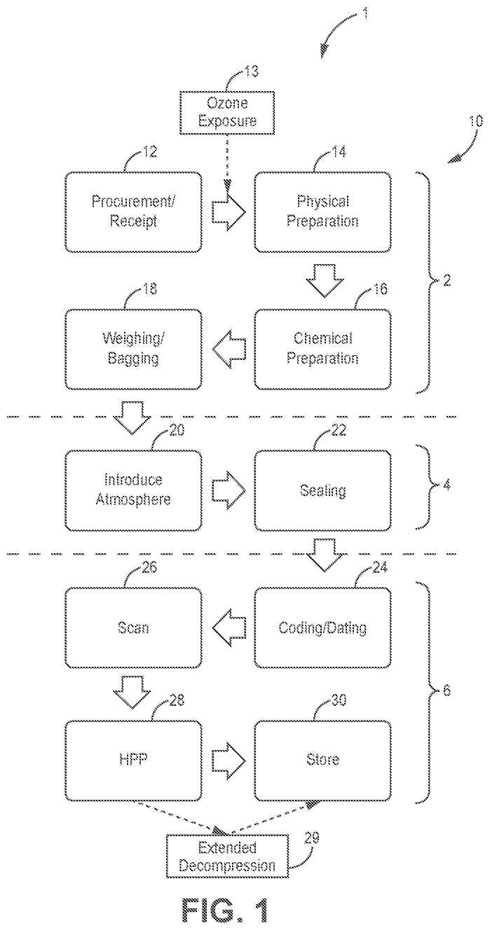

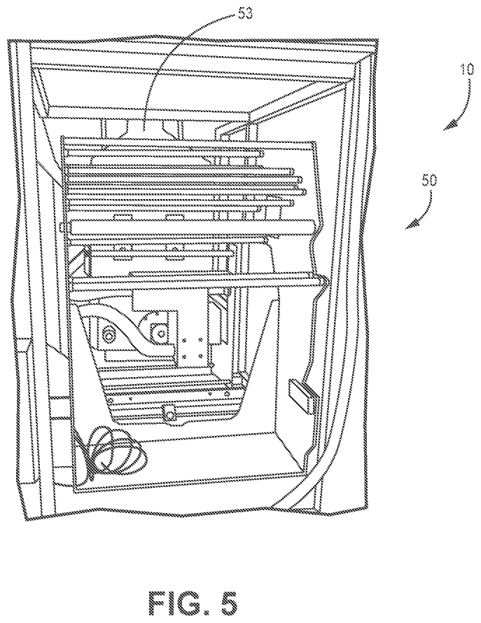

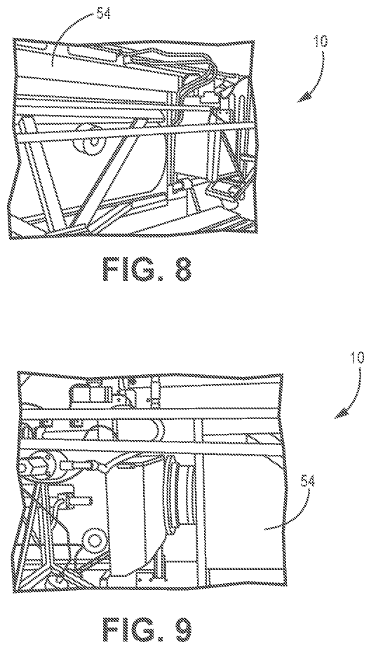

FIGS. 1-9 depict several exemplary implementations of the protein packaging process 1 executed via the operation of a packaging system 10 comprising several components, some of which may be automated or semi-automated. The various implementations relate to packaging a protein such as meat sealed in an air-tight container containing a modified atmosphere and exposed to HPP (in some implementations HPP includes exposing the product to isostatic pressures of up to about 600 MPa/87,000 psi or more) for improved shelf-life and other advantages, as is described in detail herein.

Through the combination of the aqueous ozone solution, modified atmosphere and the use of HPP with or without an extended decompression period, the various implementations allow for a significant reduction in pathogens, extended shelf-life, and/or improved aesthetic qualities of the packaged protein. In some of these implementations, the process 1 and system 10 include steps for tracking and tracing such that the final packaged protein can be traced back to the source, thereby adding another important food safety element in the supply network. It is understood that these edible proteins are considered a commodity market at one stage or another in the process or path to the end user.

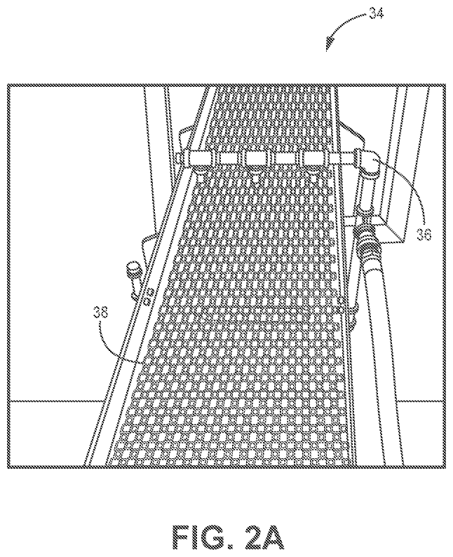

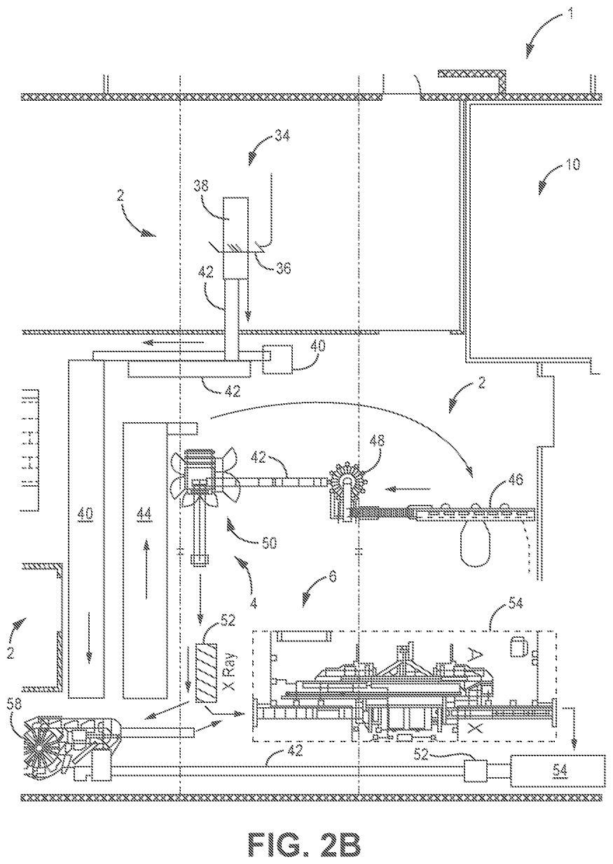

Turning to the drawings in greater detail, in the implementation of FIG. 1, the process 1 or method 1 comprises various optional steps and optional sub-steps that can be performed in any order. It is understood that in various implementations, a packaging system 10 is constructed and arranged to perform this process 1 by utilizing several components and associated devices. Various implementations of this system 10 are depicted in FIGS. 2A-9.

The disclosed implementations involve several optional steps which may be performed in any order. Additional steps and/or substep may be included, while other steps and/or substeps may be omitted, depending on the specific implementation. One example packaging system 10, shown in FIG. 1, is provided to illustrate optional steps and substeps, but is in no way intended to limit the embodiments to this particular implementation.

In these implementations, and as shown in FIG. 1, the steps in exemplary implementations of the process include:
1. an optional preparation step 2,
2. an optional modified atmosphere step 4; and
3. an optional high-pressure pasteurization step 6.
   Other steps and substeps may be included. In various aspects each of these steps 2, 4, 6 can comprise various optional sub-steps, as shown in the implementation of FIG. 1.

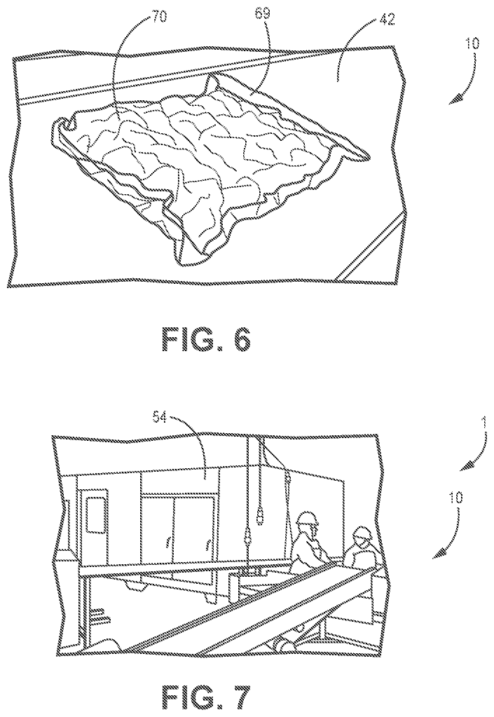

In the optional preparation step 2, according to various implementations like that of FIG. 1, a protein (shown in FIG. 6 at 70) can be procured, received, treated, and packaged in an atmosphere-resistant bag, package or other container, as described herein. In alternate implementations, the protein may be pre-bagged or otherwise contained in an air-tight container for processing in the modified atmosphere 4 and pasteurization 6 steps. In various implementations, the protein may be exposed to an aqueous ozone solution during the preparation step 2.

FIG. 1 shows one exemplary implementation of the disclosed method 1 as implemented on a packaging system 10 during the optional preparation step 2. The protein (shown in FIG. 6 at 70) may enter the system 10, through an optional procurement/receipt sub-step (box 12). In this procurement/receipt sub-step (box 12), according to certain implementations, a procurement order is issued, such as from a central processing component or computer (not shown). In these implementations, the procurement order can trigger delivery and receipt of the protein—such as meat—for cataloging via supply-chain and/or inventory systems as would be known and understood in the art.

In various implementations, the protein for processing can be one or more of fresh beef, lamb, pork, poultry, fish, fowl, bison and the like. In various implementations, more than one protein—such as a blend of chicken and beef—may be used. For example, more than one protein may be used for preparing fajitas, stir fry and/or other preparations as would be understood and appreciated in the art.

In various implementations, the preparation step 2 includes an optional ozone exposure sub-step (box 13). The protein prior to physical preparation (box 14), chemical preparation (box 16) and/or bagging (step 18)—as described further below—may be exposed to an aqueous/liquid ozone solution. In various alternative implementations, the protein is exposed to ozone after and/or during various other steps and substeps including but not limited to procurement (box 12), physical preparation (box 14), chemical preparation (box 16), and of weighing/bagging (box 18). In various implementation, the aqueous ozone solution may kill, eliminate, or otherwise render inactive various microorganisms—such as Lactobacillus and other bacteria. The aqueous ozone exposure sub-step (box 13) may be useful in targeting those bacteria/pathogens that are unaffected by HPP, modified atmosphere, and/or other preparation steps.

In the ozone exposure sub-step (box 13) the protein may be sprayed, dipped, submerged, or otherwise exposed to an aqueous ozone solution. In various implementations, the aqueous ozone solution contains about 0 to about 100 PPM of aqueous/liquid ozone. In some implementations, the aqueous ozone solution contains about 0.5 to 4 PPM of aqueous/liquid ozone. In various alternative implementations the aqueous ozone solution contains about 5 PPM of ozone.

In various implementations the aqueous ozone solution is at about 33 to 212° F. In some implementations, the temperature of the aqueous ozone solution is at ambient or room temperature. The protein may be exposed to the liquid ozone solution for about 1 to about 10 seconds or longer.

In some implementations, the aqueous ozone solution may be applied to the protein via an aqueous ozone application unit 34. In various of these implementations the aqueous ozone application unit 34 has spray nozzle(s) 36, as shown in FIGS. 2A and 2B. FIG. 2A depicts one exemplary implementation of a nozzle applicator 34 where the aqueous ozone solution is applied via multiple spray nozzles 36 positioned above a conveyor 38. In these and other implementation, the protein is placed on the conveyor 38 and passes under the nozzles 36. Of course other implementations are possible and would be recognized by those of skill in the art. In various implementations, the aqueous ozone solution is applied at a pressure of about 1 to 50 psi. In some implementations, the ozone solution is applied at a pressure of about 35 psi.

Use of the aqueous ozone exposure sub-step (box 13) with the packaging system 10 has been shown to reduce the bacterial load to zero or near 0 over a 60 day period. Additionally, use of aqueous ozone exposure has been shown to extend the shelf-life of various proteins to at least about 100 days. In one specific example, a sample of beef was exposed to ozone (as described above) and HPP (87,000 psi for 3 min) then tested for bacterial load after 60 days. In this example, the sample was found to have less than 10 cfu/g in tests for E. coli and lactic acid bacteria. Additionally, the aerobic plate count was less than 10 cfu/g and also, Listeria monocytogenes was not detected per 25 g.

In another example, a sample of beef was exposed to ozone (as described above) and HPP (72,000 psi for 3 min) then tested for bacterial load after 60 days. In this example, the sample was found to have less than 10 cfu/g in tests for E. coli and lactic acid bacteria. Additionally, the aerobic plate count was less than 10 cfu/g and also, Listeria monocytogenes was not detected per 25 g.

The results of these tests show that exposure of protein to aqueous ozone, as described herein, is useful in reducing the bacterial load of the proteins and therefore extending the shelf-life and increasing the food safety of the proteins over time. Further examples and data are given in the Experimental section below.

Turning back to the preparation step 2 of the implementation of FIG. 1 and as further shown in FIG. 2B, the entering protein can be vacuum packed, frozen, and/or fresh. An optional physical preparation sub-step (box 14) can be performed on proteins in any state. During such a physical preparation sub-step (box 14), it is understood that various preparatory techniques can be employed to prepare the protein for processing in subsequent steps and/or sub-steps of the system 10. These sub-steps may be used for conversion from subprimal or subprime material to retail presentation through understood techniques such as boning, trimming and portioning. For example, subprimal beef chuck eye roll may be cut into roast and trimmings.

As would be further appreciated, in certain implementations during the preparation step 2, according to certain aspects, a chemical preparation sub-step (box 16) is performed. During the chemical preparation sub-step (box 16), in these aspects, marinades, other treatment(s), and/or seasoning techniques may be applied to the protein. In various implementations, the chemical preparation sub-step (box 16) is performed prior to optional weighing and bagging in a weighing/bagging sub-step (box 18). It is understood that in these implementations—during the chemical preparation sub-step (box 16)—various flavored and/or neutral marinades may be introduced and/or utilized to prepare the product to a desired flavor and/or color.

In some implementations, the weighing/bagging sub-step (box 18) completes the preparation step 2. In further implementations, the optional weighing/bagging sub-step (box 18) is performed at any point in the process 1. While it is apparent that weighing is generally optional, in various implementations, the product must be bagged or otherwise inserted into an air-tight container during this weighing/bagging sub-step (box 18)—or preparation step 2 generally—to ready the protein for the modified atmosphere step 4 and/or HPP step.

In one illustrative example, the system 10 is constructed and arranged such that the pre-bagged protein is about 16 oz. In other examples, the protein is about 6 oz, 8 oz, 10 oz, 12 oz or more. In further examples, the protein weight is between about 1 oz and 64 oz. In additional implementations, the protein is more than 64 oz. In yet further examples, the protein comprises a variety of individual pieces that in sum weigh about a specified amount, such as shrimp and/or fajita cuts. It is understood that a variety of sizes and weights are possible, depending on the final retail application.

In certain implementations, the barrier film or barrier bag (shown in FIG. 6 at 69) used in the weighing/bagging sub-step (box 18) can be a nylon bag, a 3-ply bag, though other high barrier product. Other implementations are possible, including metallic, Saran®, PET, and others known and understood by those of skill in the art to have the proper gas permeability to retain the introduced modified atmosphere.

As is shown in FIG. 2B, the preparation step 2 and corresponding sub-steps can be performed, for example by way of an arrangement of tables 40 conveyors 42, graders 44 tumblers 46 and/or weighing devices 48. It is understood myriad configurations are possible, as would be understood by the skilled artisan.

In these implementations, following the preparation step 2, a modified atmosphere step 4 is performed. In some implementations, the preparation step 2 is not performed or is performed simultaneous to or after the modified atmosphere step 4. The modified atmosphere step 4 generally relates to the introduction of a modified atmosphere (“MA”) to the protein within the bag. In various implementations, the modified atmosphere is a combination of carbon monoxide, carbon dioxide, and nitrogen. As will be apparent to one of skill in the art, many additional atmospheric and gaseous compositions are possible.

In one illustrative example, the prepared, portioned, and weighed protein—such as at the end of the preparation step 2 and weighing/bagging sub-step (box 18)—is exposed to a modified atmosphere via a modified atmosphere introduction sub-step (box 20)—of the modified atmosphere step 4—and then packaged or sealed in a sealing sub-step (box 22), as shown in FIG. 1.

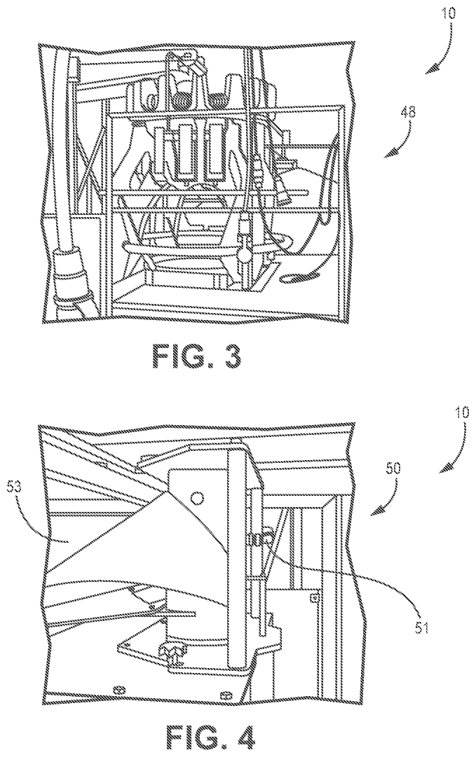

As shown in FIG. 2B, the modified atmosphere introduction sub-step (box 20) and the sealing sub-step (box 22) can be performed in rapid succession via an automatic bagger or MA device 50 and subject to further processing. It is understood that the introduction of the modified atmosphere to the protein and sealing of the package or bag can be performed in a variety of alternative ways. In certain implementations, and as shown in FIGS. 3-5, the MA device 50 is configured to package the protein/product in a barrier film within a bagging chute 53, where the bag is filled with a modified atmosphere via a conduit 51. Other filling and bagging devices, methods, and systems can be utilized in alternate implementations, as would be understood.

In certain implementations, oxygen is flushed from the protein, and the modified atmosphere includes about 0.4% carbon monoxide, about 20% carbon dioxide, and the remainder (more than 79% or about 80%) is nitrogen. It is understood that in these and other implementations, it may be desirable to exclude oxygen from the modified atmosphere.

In further implementations, the carbon monoxide concentration can be about 0.1% or less, and can increase to 0.2%, 0.3% or more, or can exceed 0.5%, 1.0% or up to 100% of the atmosphere.

Similarly, the modified atmosphere can include less than 20% carbon dioxide, down to 0.1% or less. In alternate implementations, the modified atmosphere can include more than 20% carbon dioxide, such as 25%, 30%, 40%, 50% or more, up to 100%. In all of these implementations, nitrogen can comprise the remainder of the modified atmosphere.

In certain implementations, ranges from about 0% to about 100% nitric oxide and/or carbon dioxide can also be introduced into the modified atmosphere mixture. Alternatively, other inert gases may be introduced into the modified atmosphere. However, in exemplary implementations, the modified atmosphere of many implementations does not contain oxygen, as would be readily understood by one of skill in the art.

In some implementations, the gas or gases in the modified atmosphere can be adjusted or modified based on the product or cut of meat/protein being packaged. In one specific example, for raw red meat the modified atmosphere mixture includes about 60-80% oxygen and 20-40% carbon dioxide. In another specific example, the modified atmosphere for raw light poultry includes about 40-100% carbon dioxide and 0-60% nitrogen. In another example, for raw dark poultry the modified atmosphere includes 70% oxygen and 30% carbon dioxide. In another example, for sausage the modified atmosphere includes 20-30% carbon dioxide and 70-80% nitrogen. In another example, the modified atmosphere for sliced and cooked meat includes 30% carbon dioxide and 70% nitrogen. Of course other modified atmosphere compositions are possible as would be recognized.

Continuing with the implementations of FIGS. 1-2, and FIGS. 6-9, the protein sealed in a modified atmosphere (“MA protein”—shown in FIG. 6 at 70) can be taken through a HPP step 6 comprising one or more post-sealing sub-steps via conveyors 42 and other devices used in the industry and understood in the art. In various alternative implementations, the HPP step is performed before the modified atmosphere step 4, or the modified atmosphere step 4 is omitted from the process 1.

In certain implementations, during the high-pressure pasteurization step 6 a sub-step of performing HPP is required, but several other optional sub-steps relating to processing can also be performed.

For example, after the protein has been sealed in a package (with or without modified atmosphere) (as shown in FIG. 1 box 22), the protein can optionally be bag dated or coded in a coding/dating sub-step (box 24). In another optional sub-step the protein is scanned or X-rayed in a scanning sub-step (box 26 and in FIG. 2B at 52). Various of these step and substep may ensure quality and/or compliance—such as with USDA regulations. It is understood that various white-labeling and/or other marketing badges may also be applied to the bag at or between any of these optional sub-steps of the process 1. Alternate implementations do not include these dating, coding, scanning, and x-raying sub-steps. In a further implementations the process 1 comprises additional packaging, labeling and quality-control sub-steps as would be understood in the art. It is further understood that these optional substeps of dating, coding, scanning, and x-raying can be performed at any point in the process 1 and may be performed at multiple points in the process.

Turning to FIGS. 7-9, the protein (whether or not packaged in modified atmosphere) is exposed to HPP in a HPP sub-step, as is shown in FIG. 1 at box 28 and in FIGS. 7-9 at 54.

In one implementation, the HPP sub-step (box 28) is performed at up to about 87,000 psi for a duration of about 3 minutes or more. Various alternative implementations can utilize HPP of 300-600 MPa/43,500-87,000 psi or more, over durations of from less than about a minute to more than about ten minutes, more than about 20 minutes, more than about 30 minutes, more than about 60 minutes or longer. The conditions and parameters of the HPP sub-step (box 28) may depend on the environment, conditions, and other parameters as would be recognized. Various implementations can perform the HPP sub-step (box 28) from about 1 second to about 3600 seconds or more at between about 43,500 and about 87,000 psi or more.

In various implementations, HPP (box 28) has process parameters between about 50,000 to 87,000 psi for between 3 to 5 minutes. In another implementation, the HPP (box 28) is conducted at 60,000 psi for 4 minutes.

In these and other implementation the HPP sub-step (box 28) may include an extended decompression step (box 29). In various implementations, after the HPP time has elapsed the pressure is released and the package/item is returned to atmospheric pressure. This decompression time can last from about less than one second to more than about 10 minutes. In some implementations, the decompression time is at least about 5 min. In some implementations, the decompression time is at least about 8 minutes or more.

The extended decompression step (box 29) may provide additional time that the product/protein is exposed to pressures above atmospheric pressure. By exposing the protein to pressures of longer periods it is understood that the amount of bacterial killed may increase. Additionally, allowing additional time for decompression after HPP has been shown to improve the food quality as well as maintain the aesthetic appearance to the protein/product, such as the food color, when compared to products subject to HPP where the high pressure is released and the product returned to atmospheric pressure instantly or over a very short time period, such as a few seconds.

In certain implementations, the temperature for all steps and substeps of the process 1 is kept below about 50 degrees Fahrenheit, though alternate implementations may vary from freezing to room-temperature or higher.

It will be appreciated by the skilled artisan that the HPP sub-step (box 28) does not cause the rupture of the bag in these implementations because the pressure is being applied to the bag or other air-tight or sufficiently gaseous-impermeable container uniformly.

In various implementations, the high-pressure pasteurized packages are subsequently dried and packed in a case and palletized in a storage sub-step, as is shown in FIG. 1 at box 30 and in FIG. 2B at 56.

In certain implementations, the system 10 can further comprise a water bath. For example, a 180 degree Fahrenheit (° F.) water bath may be used, or any other bath from about 33 degrees Fahrenheit (° F.) or more. In various of these implementations, the system 10 is able to pull a vacuum (shown in FIG. 2B at 58) on the sealed bag 69. These implementations may result in a freezable product that can be provided to commercial outlets. In some of these implementations freezing may affect the color of the protein, wherein the protein turns an undesirable color.

Alternatively, however, as would be understood by one of skill in the art, the sealed protein 70 can either be exposed to MA or be vacuum packed rather than or in addition to being frozen. Accordingly, in certain implementations of the system, an alternate route or series of steps and substeps can be performed such that processing for vacuum packing and MA processing can both be performed in the same facility at substantially the same time as the process 1.

In various implementations, the finished product bags will be about 1 lb. each, and can be packaged in 40 lb. boxes on 1800 lb. pallets, so as to present an economically viable shipping method. Other configurations are of course possible, as would be appreciated by one of skill in the art.

The product treated with the process 1 described herein may remain edible in the fresh state and have a shelf-life as follows: beef/lamb about 60 days, pork about 45 days and chicken about 30 days. In some implementations, the product is to remain refrigerated at about 28 to 36 degrees Fahrenheit (° F.) during this period. In various implementations, the product can be stored at about 2-6° C. (35-43° F.). Use of the aqueous ozone exposure sub-step (box 13) and/or extended decompression sub-step (box 29) may further extend shelf-life.

In various implementations, the disclosed system 10 and associated devices, and methods also provide an extended protein shelf life for retailers, and a safer product for end consumers. Given the differences in advertising cycles and shelf life in the current retail environment, retailers typically purchase advertising at least a month prior to the actual purchase of proteins. Typically, these ads are driven on the basis of seasonal trends, and tend to “lock” the retailer into a sales promotion for the designated period. The presently-disclosed system 10 and associated, devices and methods may allow a retailer to defer or minimize this marketing decision, thus allowing retailers to select less-expensive cuts of product when suppliers have excess, thereby keeping costs down and creating efficiency. As described herein, protein from various market buys can be held for a period of time, for example about 30 to 50 days, then processed using the presently disclosed system 10 and associated methods and devices. By processing with the disclosed system 10 the protein is provided with an additional shelf life of up to about 60 days or longer. These improvements will be appreciated by those of skill in the art in light of the present disclosure.

It is understood that the improved product presentation of the protein according to various implementations will provide numerous benefits to end retailers, who will have a clean, extended shelf-life product that does not require trimming, boning, packaging and the like. Various of these retailers will therefore enjoy less overhead, while reducing the need for skilled labor. The traceable, and in some implementations privately labeled, product can be placed directly in a fresh protein counter. These packaged protein units, utilizing the disclosed system 10, may also benefit end consumers, who in turn will be purchasing a high quality portion of protein, which is safe, has normal aesthetic qualities, and can be traced back to its source facility. Additionally, for retailers the disclosed system 10 provides proteins and other products that require no or minimal product rework and decrease shrinkage. As such the overall number of preparation steps for the proteins carried by the retailer may be reduced. Further, as discussed above, a retailer can take advantage of avoiding the peak times of the year for buying particular products, while still being able to sell into the seasonal trends.

### EXPERIMENTAL

Various implementations of the above described process were carried out on various cuts of meat and then subject to testing for bacterial load. TESTS 1-15 were conducted with the following process parameters: (box 13) Ozone application at >5 ppm; (box 28) HPP at 60,000 psi for 240 seconds with a water temperature of 40° F.; (box 29) HPP extended decompression time of 486 seconds; and (box 20) Modified Atmosphere Packaging with a gas mixture of 80% N2, 19.6% CO2, and 0.4% CO. Testing was conducted prior to processing, after processing, and at subsequent approximately 10-day intervals.

TEST 1: Chuck Blade Steak

| | | | E. Coli | Aerobic | Anerobic | |
|---|---|---|---|---|---|---|
| | | Coliforms | Generic | Plate | Plate | |
| Test | Date | (CFU/g) | (CFU/g) | Count | Count | Listeria |
| 1 - before | Aug. 19, | <10 | <10 | 540,000 | <10 | ND |
| treatment | 2019 | | | | | |
| 2 - after | Aug. 19, | <10 | <10 | 540 | <10 | ND |
| treatment | 2019 | | | | | |
| 3 | Aug. 27, | <10 | <10 | 26,000 | <10 | ND |
| | 2019 | | | | | |
| 4 | Sep. 6, | <10 | <10 | N/A | N/A | ND |
| | 2019 | | | | | |

TEST 2: Clod Heart Steak

| | | | E. Coli | Aerobic | Anerobic | |
|---|---|---|---|---|---|---|
| | | Coliforms | Generic | Plate | Plate | |
| Test | Date | (CFU/g) | (CFU/g) | Count | Count | Listeria |
| 1 | Aug. 19, | 100 | <10 | 57,000 | <10 | ND |
| | 2019 | | | | | |
| 2 | Aug. 19, | <10 | <10 | 30 | 10 | ND |
| | 2019 | | | | | |
| 3 | Aug. 27, | <10 | <10 | 60 | <10 | ND |
| | 2019 | | | | | |
| 4 | Sep. 6, | <10 | <10 | 60,000 | 42,000 | ND |
| | 2019 | | | | | |

TEST 3: Beef Ribeye Steak

| | | | E. Coli | Aerobic | Anerobic | |
|---|---|---|---|---|---|---|
| | | Coliforms | Generic | Plate | Plate | |
| Test | Date | (CFU/g) | (CFU/g) | Count | Count | Listeria |
| 1 | Aug. 19, | 90 | <10 | 5,800 | <10 | ND |
| | 2019 | | | | | |
| 2 | Aug. 19, | <10 | <10 | <10 | <10 | ND |
| | 2019 | | | | | |
| 3 | Aug. 27, | <10 | <10 | 50 | <10 | ND |
| | 2019 | | | | | |
| 4 | Sep. 6, | <10 | <10 | <10 | <10 | ND |
| | 2019 | | | | | |

TEST 4: Beef sirloin tri tip

| | | | E. Coli | Aerobic | Anerobic | |
|---|---|---|---|---|---|---|
| | | Coliforms | Generic | Plate | Plate | |
| Test | Date | (CFU/g) | (CFU/g) | Count | Count | Listeria |
| 1 | Aug. 19, | <10 | <10 | 350,000 | 210,000 | ND |
| | 2019 | | | | | |
| 2 | Aug. 19, | <10 | <10 | 500 | 140 | ND |
| | 2019 | | | | | |
| 3 | Aug. 27, | <10 | <10 | 240,000 | <10 | ND |
| | 2019 | | | | | |
| 4 | Sep. 6, | <10 | <10 | 320,000 | 150,000 | ND |
| | 2019 | | | | | |

TEST 5: Beef Top Butt

| | | | E. Coli | Aerobic | Anerobic | |
|---|---|---|---|---|---|---|
| | | Coliforms | Generic | Plate | Plate | |
| Test | Date | (CFU/g) | (CFU/g) | Count | Count | Listeria |
| 1 | Aug. 19, | <10 | <10 | 660,000 | 970,000 | ND |
| | 2019 | | | | | |
| 2 | Aug. 19, | <10 | <10 | 10 | <10 | ND |
| | 2019 | | | | | |
| 3 | Aug. 27, | <10 | <10 | 7,800 | 8,400 | ND |
| | 2019 | | | | | |
| 4 | Sep. 6, | <10 | <10 | 540,000 | >250,000 | ND |
| | 2019 | | | | | |

TEST 6: Beef Eye of Round

| | | | E. Coli | Aerobic | Anerobic | |
|---|---|---|---|---|---|---|
| | | Coliforms | Generic | Plate | Plate | |
| Test | Date | (CFU/g) | (CFU/g) | Count | Count | Listeria |
| 1 | Aug. 19, | <10 | <10 | 360,000 | 800,000 | ND |
| | 2019 | | | | | |
| 2 | Aug. 19, | <10 | <10 | 20 | <10 | ND |
| | 2019 | | | | | |
| 3 | Aug. 27, | <10 | <10 | 14,000 | <10 | ND |
| | 2019 | | | | | |
| 4 | Sep. 6, | <10 | <10 | NA | NA | ND |
| | 2019 | | | | | |

TEST 7: Beef Inside Round Steak

| | | | E. Coli | Aerobic | Anerobic | |
|---|---|---|---|---|---|---|
| | | Coliforms | Generic | Plate | Plate | |
| Test | Date | (CFU/g) | (CFU/g) | Count | Count | Listeria |
| 1 | Aug. 19, | 10 | <10 | 5,600 | 5,700 | ND |
| | 2019 | | | | | |
| 2 | Aug. 19, | <10 | <10 | <10 | 10 | ND |
| | 2019 | | | | | |
| 3 | Aug. 27, | <10 | <10 | 7,200 | <10 | ND |
| | 2019 | | | | | |
| 4 | Sep. 6, | <10 | <10 | NA | NA | ND |
| | 2019 | | | | | |

TEST 8: Beef Bottom Sirloin Flap Meat

| | | | E. Coli | Aerobic | Anerobic | |
|---|---|---|---|---|---|---|
| | | Coliforms | Generic | Plate | Plate | |
| Test | Date | (CFU/g) | (CFU/g) | Count | Count | Listeria |
| 1 | Aug. 19, | <10 | <10 | 530,000 | 1,200,000 | ND |
| | 2019 | | | | | |
| 2 | Aug. 19, | <10 | <10 | 10 | <10 | ND |
| | 2019 | | | | | |
| 3 | Aug. 27, | <10 | <10 | <10 | <10 | ND |
| | 2019 | | | | | |
| 4 | Sep. 6, | <10 | <10 | NA | NA | ND |
| | 2019 | | | | | |

TEST 9:

| | | | E. Coli | Aerobic | Anerobic | |
|---|---|---|---|---|---|---|
| | | Coliforms | Generic | Plate | Plate | |
| Test | Date | (CFU/g) | (CFU/g) | Count | Count | Listeria |
| 1 | Aug. 19, | 10 | <10 | 1,200 | 550 | ND |
| | 2019 | | | | | |
| 2 | Aug. 19, | <10 | <10 | 10 | <10 | ND |
| | 2019 | | | | | |
| 3 | Aug. 27, | <10 | <10 | 40 | <10 | ND |
| | 2019 | | | | | |
| 4 | Sep. 6, | <10 | <10 | 4,500 | 70 | ND |
| | 2019 | | | | | |

TEST 10: Pork Boneless Loin

| | | | | E. Coli | Aerobic | Anerobic | |
|---|---|---|---|---|---|---|---|
| | | | Coliforms | Generic | Plate | Plate | |
| Test | Time | Date | (CFU/g) | (CFU/g) | Count | Count | Listeria |
| 1 | 0 - before | Apr. 19, | 10 | <10 | 1,200 | 550 | ND |
| | treatment | 2019 | | | | | |
| 2 | 0 - after | Apr. 19, | <10 | <10 | <10 | <10 | ND |
| | treatment | 2019 | | | | | |
| 3 | 1 | Aug. 27, | <10 | <10 | 20 | <10 | ND |
| | | 2019 | | | | | |
| 4 | 2 | Sep. 6, | <10 | <10 | 290,000 | 190,000 | ND |
| | | 2019 | | | | | |

TEST 11: Pork Bone In Loin

| | | | | E. Coli | Aerobic | Anerobic | |
|---|---|---|---|---|---|---|---|
| | | | Coliforms | Generic | Plate | Plate | |
| Test | Time | Date | (CFU/g) | (CFU/g) | Count | Count | Listeria |
| 1 | 0 - before | Aug. 19, 2019 | <10 | <10 | 470 | <10 | ND |
| | treatment | | | | | | |
| 2 | 0 - after | Aug. 19, 2019 | <10 | <10 | 30 | <10 | ND |
| | treatment | | | | | | |
| 3 | 1 | Aug. 27, 2019 | <10 | <10 | 10 | <10 | ND |
| 4 | 2 | Sep. 6, 2019 | <10 | <10 | NA | NA | ND |

TEST 12: Pork Loin Ground

| | | | | E. Coli | Aerobic | Anerobic | |
|---|---|---|---|---|---|---|---|
| | | | Coliforms | Generic | Plate | Plate | |
| Test | Time | Date | (CFU/g) | (CFU/g) | Count | Count | Listeria |
| 1 | 0 - before | Aug. 19, 2019 | <10 | <10 | 320 | <10 | ND |
| | treatment | | | | | | |
| 2 | 0 - after | Aug. 19, 2019 | <10 | <10 | <10 | <10 | ND |
| | treatment | | | | | | |
| 3 | 1 | Aug. 27, 2019 | <10 | <10 | 50 | <10 | ND |
| 4 | 2 | Sep. 6, 2019 | <10 | <10 | 33,000 | 18,000 | ND |

TEST 13: Chicken Thigh

| | | | | | Aerobic | Anerobic | |
|---|---|---|---|---|---|---|---|
| | | | Coliforms | | Plate | Plate | |
| Test | Time | Date | (CFU/g) | Salmonella | Count | Count | Listeria |
| 1 | 0 - before | Aug. 19, 2019 | <10 | ND | 130,000 | 70,000 | ND |
| | treatment | | | | | | |
| 2 | 0 - after | Aug. 19, 2019 | <10 | ND | 140 | <10 | ND |
| | treatment | | | | | | |
| 3 | 1 | Aug. 27, 2019 | <10 | ND | 900 | <10 | ND |

TEST 14: Chicken Breast

| | | | | | Aerobic | Anerobic | |
|---|---|---|---|---|---|---|---|
| | | | Coliforms | | Plate | Plate | |
| Test | Time | Date | (CFU/g) | Salmonella | Count | Count | Listeria |
| 1 | 0 - before | Aug. 19, 2019 | <10 | ND | 120 | <10 | ND |
| | treatment | | | | | | |
| 2 | 0 - after | Aug. 19, 2019 | <10 | ND | <10 | <10 | ND |
| | treatment | | | | | | |
| 3 | 1 | Aug. 27, 2019 | <10 | ND | <10 | <10 | ND |

TEST 15: Ground Chicken

| | | | | | Aerobic | Anerobic | |
|---|---|---|---|---|---|---|---|
| | | | Coliforms | | Plate | Plate | |
| Test | Time | Date | (CFU/g) | Salmonella | Count | Count | Listeria |
| 1 | 0 - before | Aug. 19, 2019 | <10 | ND | 40 | <10 | ND |
| | treatment | | | | | | |
| 2 | 0 - after | Aug. 19, 2019 | <10 | ND | 10 | <10 | ND |
| | treatment | | | | | | |
| 3 | 1 | Aug. 27, 2019 | <10 | ND | 10 | <10 | ND |

Tests A-E tested the application of ozone (box 13) to meat products and varying HPP (box 28) process parameters over time.

TEST A: Beef Not Ground

| | | E. Coli | Aerobic | Anerobic | |
|---|---|---|---|---|---|
| Days | Date | General CFU/g | Plate Count | plate count | Listeria |
| 0-before | Feb. 27, 2019 | <10 | 130 | 430 | ND |
| 0-after | Feb. 27, 2019 | <10 | <10 | <10 | ND |
| 22 | Mar. 20, 2019 | <10 | <10 | <10 | ND |
| 43 | Apr. 12, 2019 | <10 | 170,000 | <10 | ND |
| 50 | Apr. 19, 2019 | <10 | <10 | <10 | ND |
| 60 | Apr. 29, 2019 | <10 | <10 | <10 | ND |
| 70 | May 9, 2019 | <10 | >3,000,000 | <10 | ND |
| 81 | May 20, 2019 | <10 | 1,300,000 | <10 | ND |

* HPP 72 K for 3 min; Ozone application

TEST B: Chicken Breast

| | | E. Coli | Aerobic | Anerobic | | |
|---|---|---|---|---|---|---|
| | | General | Plate | plate | | |
| Days | Date | CFU/g | Count | count | Salmonella | Listeria |
| 0 | Feb. 27, 2019 | <10 | <10 | <10 | ND | ND |
| 22 | Feb. 27, 2019 | <10 | 800,000 | 160,000 | ND | ND |

* HPP 72K for 3 min; Ozone application

TEST C: Chicken Breast

| | | E. Coli | Aerobic | Anerobic | | |
|---|---|---|---|---|---|---|
| | | General | Plate | plate | | |
| Days | Date | CFU/g | Count | count | Salmonella | Listeria |
| 0 - before | Feb. 27, 2019 | <10 | >3,000,000 | 2,600,000 | ND | ND |
| 0- after | Feb. 27, 2019 | <10 | 80 | <10 | ND | ND |
| 22 | Mar. 20, 2019 | <10 | 990,000 | 600,000 | ND | ND |

* HPP 70K for 3 min; Ozone application

TEST D: Beef—not ground

| | | E. Coli | Aerobic | Anerobic | |
|---|---|---|---|---|---|
| Days | Date | General CFU/g | Plate Count | plate count | Listeria |
| 0-before | Feb. 27, 2019 | <10 | 50 | 20 | ND |
| 0-after | Feb. 27, 2019 | <10 | 30 | 50 | ND |
| 22 | Mar. 20, 2019 | <10 | <10 | 120 | ND |
| 43 | Apr. 12, 2019 | <10 | 10 | <10 | ND |
| 50 | Apr. 19, 2019 | <10 | 70 | <10 | ND |
| 60 | Apr. 29, 2019 | <10 | <10 | <10 | ND |
| 70 | May 9, 2019 | <10 | <10 | <10 | ND |
| 81 | May 20, 2019 | <10 | <10 | <10 | ND |

* HPP 87 K for 3 min; Ozone Application

Tests E-L related to applying various process parameters to a ¼ chicken. TEST E reflects microbial values of the chicken before any processing via the process 1. TEST F reflects microbial values of the chicken after an ozone application step (box 13). TESTS G-L reflect microbial values after treatment with HPP (box 28) with the processing parameters indicated.

TEST E: ¼ Chicken

| | | E. Coli | Aerobic | Anerobic | | |
|---|---|---|---|---|---|---|
| | | General | Plate | plate | | |
| Days | Date | CFU/g | Count | count | Salmonella | Listeria |
| 0 | Feb. 28, 2019 | <10 | 290,000 | <10 | ND | ND |

* before treatment

TEST F: ¼ Chicken

| | | E. Coli | Aerobic | Anerobic | | |
|---|---|---|---|---|---|---|
| | | General | Plate | plate | | |
| Days | Date | CFU/g | Count | count | Salmonella | Listeria |
| 0 - | Feb. 28, 2019 | <10 | 70,000 | <10 | ND | ND |
| after | | | | | | |
| 12 | Mar. 11, 2019 | <10 | 2,900,000 | 950,000 | ND | ND |

* Ozone Application

TEST G: ¼ Chicken

| | | E. Coli | Aerobic | Anerobic | | |
|---|---|---|---|---|---|---|
| | | General | Plate | plate | | |
| Days | Date | CFU/g | Count | count | Salmonella | Listeria |
| 0 - | Feb. 28, 2019 | <10 | 140 | 30 | ND | ND |
| after | | | | | | |
| 12 | Mar. 11, 2019 | <10 | 1,600,000 | <10 | ND | ND |

* HPP 50K for 4 min

TEST H: ¼ Chicken

| | | E. Coli | Aerobic | Anerobic | | |
|---|---|---|---|---|---|---|
| | | General | Plate | plate | | |
| Days | Date | CFU/g | Count | count | Salmonella | Listeria |
| 0 | Feb. 28, 2019 | <10 | 140 | 30 | ND | ND |
| 12 | Mar. 11, 2019 | <10 | 2,800,000 | 100,000 | ND | ND |

* HPP 50K for 5 min

TEST I: ¼ Chicken

| | | E. Coli | Aerobic | Anerobic | | |
|---|---|---|---|---|---|---|
| | | General | Plate | plate | | |
| Days | Date | CFU/g | Count | count | Salmonella | Listeria |
| 0 | Feb. 28, 2019 | <10 | 60 | <10 | ND | ND |
| 12 | Mar. 11, 2019 | <10 | 150,000 | 140,000 | ND | ND |
| 20 | Mar. 19, 2019 | <10 | >3,000,000 | 4,400 | ND | ND |

* HPP 60K for 4 min

TEST J: ¼ Chicken

| | | E. Coli | Aerobic | Anerobic | | |
|---|---|---|---|---|---|---|
| | | General | Plate | plate | | |
| Days | Date | CFU/g | Count | count | Salmonella | Listeria |
| 0 | Feb. 28, 2019 | <10 | 60 | <10 | ND | ND |
| 12 | Mar. 11, 2019 | <10 | 110,000 | 89,000 | ND | ND |
| 20 | Mar. 19, 2019 | <10 | >3,000,000 | 470,000 | ND | ND |

* HPP 60K for 5 min

TEST K: ¼ Chicken

| | | E. Coli | Aerobic | Anerobic | | |
|---|---|---|---|---|---|---|
| | | General | Plate | plate | | |
| Days | Date | CFU/g | Count | count | Salmonella | Listeria |
| 0 | Feb. 28, 2019 | <10 | 10 | <10 | ND | ND |
| 12 | Mar. 11, 2019 | <10 | 170,000 | <10 | ND | ND |
| 20 | Mar. 19, 2019 | <10 | >3,000,000 | 21,000 | ND | ND |

* HPP 70K for 4 min

TEST L: ¼ Chicken

| | | E. Coli | Aerobic | Anerobic | | |
|---|---|---|---|---|---|---|
| | | General | Plate | plate | | |
| Days | Date | CFU/g | Count | count | Salmonella | Listeria |
| 0 | Feb. 28, 2019 | <10 | 10 | <10 | ND | ND |
| 12 | Mar. 11, 2019 | <10 | 19,000 | 14,000 | ND | ND |

* HPP 70K for 5 min

Another set of tests were conducted on beef sirloin flap meat using various process parameters and including or omitted various steps and/or substeps. In tests using Modified Atmosphere Packaging (“MAP”) a gas mixture of 80% N, 19.6% CO2, and 0.4% CO was used.

| | Total Coliforms | E. Coli | Aerobic Plate |
|---|---|---|---|
| Process | (CFU/g) | (CFU/g) | Count (CFU/g) |
| Vacuum Packed | 200 | <10 | 7700 |
| Ozone Applied; Vacuum | 560 | <10 | 7700 |
| Packed | | | |
| Ozone Applied; MAP | 90 | <10 | 6800 |
| Ozone applied; MAP; | <10 | <10 | 680 |
| HPP 50 K for 4 min | | | |
| Ozone applied; MAP; | <10 | <10 | 350 |
| HPP 50 K for 5 min | | | |
| Ozone applied; MAP; | <10 | <10 | 2800 |
| HPP 50 K for 6 min | | | |
| Ozone applied; MAP; | <10 | <10 | 470 |
| HPP 60 K for 4 min | | | |

Although the disclosure has been described with reference to preferred embodiments, persons skilled in the art will recognize that changes may be made in form and detail without departing from the spirit and scope of the disclosed apparatus, systems and methods.

What is claimed is:

1. A method for packaging proteins comprising:
a preparation step comprising:
providing a protein;
exposing the protein to a aqueous ozone solution; and
placing the protein in a container;
a modified atmosphere step comprising:
introducing a modified atmosphere into the container and
sealing the container; and
a high-pressure pasteurization step comprising:
exposing the container to high pressure pasteurization and
storing the container.

2. The method of claim 1, wherein the liquid ozone solution is about 0.5 to about 5 PPM

3. The method of claim 2, wherein the protein is exposed to the aqueous ozone solution for 1 to 10 seconds.

4. The method of claim 3, further comprising extending decompression time after high pressure pasteurization.

5. The method of claim 4, wherein the decompression time is about 8 min.

6. The method of claim 1, wherein the high-pressure pasteurization is at least about 60,000 psi.

7. The method of claim 6, wherein the high-pressure pasteurization is at least about 4 minutes.

8. A method for extending the shelf life of a food product comprising:
providing a food product;
exposing the food product to an aqueous ozone solution;
placing the food product into a package;
flushing the package with a modified atmosphere;
sealing the package; and
exposing the package to high pressure pasteurization.

9. The method of claim 8, wherein the food product is exposed to the aqueous ozone solution for 1 to 10 seconds.

10. The method of claim 9, wherein the aqueous ozone solution comprises 0.5 to 4 PPM of aqueous ozone.

11. The method of claim 8, wherein the modified atmosphere is substantially without oxygen.

12. The method of claim 8, wherein aqueous ozone solution is exposed to the food product via spray nozzles.

13. The method of claim 8, wherein the high pressure pasteurization has a decompression time greater than 5 minutes.

14. A system for processing proteins comprising:
a. an aqueous ozone application unit;
b. a packager in communication with to the aqueous ozone application unit;
c. a modified atmosphere injector in communication with the packager;
d. a sealer in communication with the packager and modified atmosphere injector; and
e. a high-pressure pasteurization tank in connection with the packager,
wherein:
a. a protein is exposed to aqueous ozone in the aqueous ozone application unit;
b. the protein is placed into a package by the packager;
c. the package is flushed with a modified atmosphere by the modified atmosphere injector;
d. the package is sealed by the sealer while flushed with the modified atmosphere; and
e. the protein is exposed to high-pressure pasteurization in the high-pressure pasteurization tank.

15. The system of claim 14, wherein the aqueous ozone solution is 0.5 to 4 PPM of aqueous ozone.

16. The system of claim 15, wherein the aqueous ozone application unit comprises at least one spray nozzle.

17. The system of claim 16, wherein the high pressure pasteurization has an extended decompression time.

18. The system of claim 17, wherein the decompression time is greater than 8 minutes.

19. The system of claim 18, wherein the self-life of the protein is extended by at least 60 days.

20. The system of claim 19, wherein the protein is beef.
